(19) United States
(12) Patent Application Publication
(10) Pub. No.: US 2026/0176113 A1
(43) Pub. Date: Jun. 25, 2026

(54) Moving Method and Structural Device Thereof

(71) Applicant: BRIGHTEST TECHNOLOGY TAIWAN CO., LTD., Hsinchu County (TW)

(72) Inventors: Ching-Teng Fan, Hsinchu County (TW); Kuo-Feng Tseng, Santa Clara, CA (US)

(73) Assignee: BRIGHTEST TECHNOLOGY TAIWAN CO., LTD., Hsinchu County (TW)

(21) Appl. No.: 18/988,956

(22) Filed: Dec. 20, 2024

(51) Int. Cl. B66F 3/24

(52) U.S. Cl. CPC B66F 3/247

(57) ABSTRACT

A moving method for progressively moving a bottom chamber away from a top chamber includes decreasing a height of a height adjustable device to lower the bottom chamber; inflating a pneumatic lifting device until the bottom chamber is supported by the pneumatic lifting device and separated from the height adjustable device or a first spacer device; removing the first spacer device; deflating the pneumatic lifting device until the bottom chamber is supported by the height adjustable device and separated from a second spacer; removing the second spacer; inflating the pneumatic lifting device until the bottom chamber is supported by the pneumatic lifting device and separated from the height adjustable device; removing the height adjustable device; and deflating the pneumatic lifting device until the bottom chamber is supported by a plate and separated from the pneumatic lifting device.

### BACKGROUND OF THE INVENTION

### 1. Field of the Invention

The present invention relates to a moving method and structural device thereof, and more particularly, to a moving method and structural device thereof that improve.

### 2. Description of the Prior Art

The challenge in a confined space with a height limitation is how to safely and efficiently lift heavy objects beyond the capacity of manual handling, while enabling both vertical lifting and horizontal movement. However, current options come with inherent trade-offs between smooth vertical lifting, horizontal mobility, and overall thickness.

### SUMMARY OF THE INVENTION

It is therefore a primary objective of the present application to provide a moving method and structural device thereof, to improve over disadvantages of the prior art.

An embodiment of the present invention discloses a moving method, for progressively moving a bottom chamber away from a top chamber, wherein the moving method comprises decreasing a height of a height adjustable device to lower the bottom chamber; inflating a pneumatic lifting device until the bottom chamber is supported by the pneumatic lifting device and separated from the height adjustable device or a first spacer device, wherein the first spacer device is mountable on or beneath the height adjustable device; removing the first spacer device; deflating the pneumatic lifting device until the bottom chamber is supported by the height adjustable device and separated from a second spacer, wherein the second spacer is mountable on the pneumatic lifting device; removing the second spacer; inflating the pneumatic lifting device until the bottom chamber is supported by the pneumatic lifting device and separated from the height adjustable device; removing the height adjustable device; and deflating the pneumatic lifting device until the bottom chamber is supported by a plate and separated from the pneumatic lifting device.

An embodiment of the present invention discloses a moving method, for progressively moving a bottom chamber toward a top chamber, wherein the moving method comprises inflating a pneumatic lifting device on a plate until the bottom chamber is supported by the pneumatic lifting device; placing a height adjustable device on the plate; deflating the pneumatic lifting device until the bottom chamber is supported by the height adjustable device and separated from the pneumatic lifting device; placing a second spacer on the pneumatic lifting device; inflating the pneumatic lifting device until the bottom chamber is supported by the pneumatic lifting device and separated from the height adjustable device; placing a first spacer device on or beneath the height adjustable device; deflating the pneumatic lifting device until the bottom chamber is supported by the height adjustable device and separated from the second spacer; increasing a height of the height adjustable device to lift the bottom chamber.

An embodiment of the present invention discloses a structural device, for progressively moving a bottom chamber either away from or toward a top chamber, wherein the structural device comprises a plate; a first spacer device, mountable on the plate; a height adjustable device, mountable on or beneath the first spacer device, wherein the height adjustable device comprises at least one simple machine to adjust a height thereof; a pneumatic lifting device, mountable on the plate, wherein the pneumatic lifting device is inflatable and deflatable to adjust a height thereof; a second spacer, mountable on the pneumatic lifting device; wherein the bottom chamber is mountable on the plate, the height adjustable device, the first spacer device, the pneumatic lifting device, or the second spacer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-4 are schematic diagrams of a system according to according to an embodiment of the present invention.

FIG. 5 is a flowchart of a moving method according to an example of the present invention.

FIGS. 6-10 are schematic diagrams of a system according to according to an embodiment of the present invention.

### DETAILED DESCRIPTION

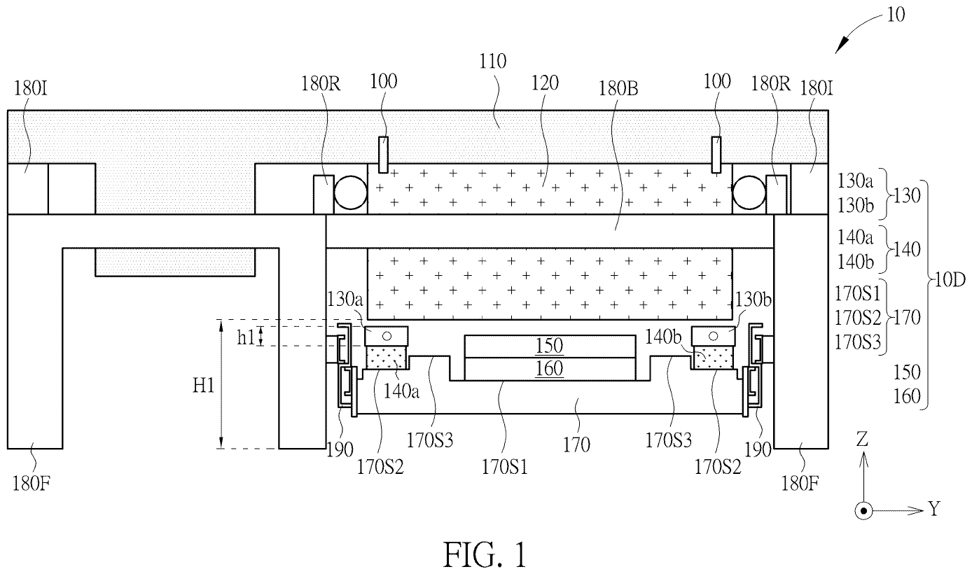

FIGS. 1-4 are schematic diagrams of a system 10 according to an embodiment of the present invention. The system 10 comprises a top chamber 110, a bottom chamber 120, and a structural device 10D.

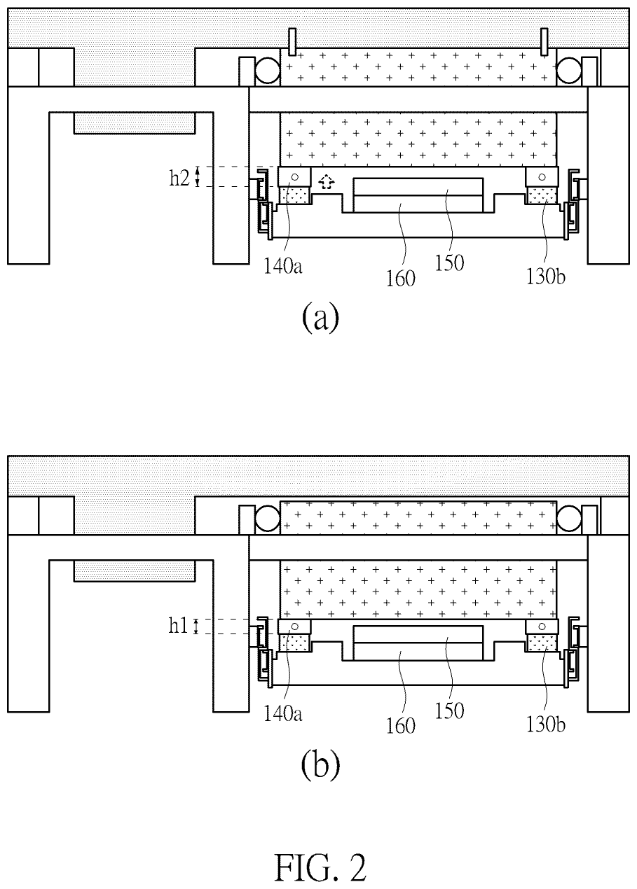

FIGS. 1-2 illustrate the assembly/disassembly process of the top chamber 110 and the bottom chamber 120. When connected to each other, as shown in FIG. 1, the top chamber 110, which serves as a mating lid mountable on a frame 180F and components 180I, and the bottom chamber 120, which serves as a mating container, are assembled into a unified device (e.g., an inspection device). The bottom chamber 120 may be secured to the top chamber 110 using fastener(s) 100 (e.g., screw(s)), or it may be restrained laterally by a (bar) frame 180B to prevent unintended movement of the bottom chamber 120. When the top chamber 110 and the bottom chamber 120 are disconnected as shown in FIG. 2(a), the bottom chamber 120 can be extracted for repairing, replacement, or routine maintenance.

However, removing the bottom chamber 120 can be challenging. As shown in FIGS. 1-4, the height of the top chamber 110 and the volume of the bottom chamber 120 limits the movement of the bottom chamber 120 to a confined area. To efficiently raise or lower the heavy bottom chamber 120 between different elevations within the confined area, the present invention proposes the structural device 10D.

The structural device 10D comprises a height adjustable device 130 and a pneumatic lifting device 160, by the side of the height adjustable device 130. Together, these components facilitate the progressive separation of the bottom chamber from the top chamber 110, or the gradual assembly of the two paired chambers 110 and 120, even within the confined space, as will be described below (e.g., step S507). The height adjustable device 130 comprises leveling wedges (e.g., 130a-130b) or simple machine(s) (e.g., a wedge) to be adjustable in height. The height of the height adjustable device 130 may be adjusted by turning its wedge screw(s). The pneumatic lifting device 160 (e.g., an air caster) is inflatable and deflatable to enable height adjustment.

Optionally, the structural device 10D may further comprise spacer device(s) (e.g., 140), each comprising spacer(s) (e.g., 140a-140b) mountable on or beneath the height adjustable device 130, or spacer(s) (e.g., 150), mountable on the pneumatic lifting device 160. Specifically, it may be necessary to elevate/lower the bottom chamber 120 to a higher/lower elevation than that can be achieved by a single stroke of the height adjustable device 130 or the pneumatic lifting device 160. To address this need, the structural device 10D incorporates the spacer(s), which is/are releasable connected to the height adjustable device 130 or the pneumatic lifting device 160. The spacer(s) may be added to or removed incrementally from the height adjustable device 130 or the pneumatic lifting device 160, as will be described below (e.g., step S514), to extend the lifting/lowering range. By utilizing the spacer(s), the bottom chamber 120 can be efficiently moved to elevations beyond what a single stroke of either component alone can achieve. For example, with a well-designed combination of the height adjustable device 130, the pneumatic lifting device 160, the spacer(s), the bottom chamber 120, weighing up to one ton, may be moved to any practical height within the practical confines of a maximum space of 64 millimeters.

The height adjustable device 130, the pneumatic lifting device 160, and the spacer(s) are sufficiently light in weight (e.g., less than 30 kilograms), allowing them to be easily carried and installed by a single worker. Despite their light weight, the stiffness or hardness of the height adjustable device 130, the pneumatic lifting device 160, and the spacer(s) is high to resist deformation and endure stress. They may, for example, comprise materials such as steel or metal and feature a thickness of 20-30 millimeters.

The structural device 10D further comprises a plate 170, which supports the height adjustable device 130, the pneumatic lifting device 160, or the spacer(s). The plate 170 is slidable along a slide rail 190 of the structural device 10D enables horizontal movement of the heavy bottom chamber 120 as needed.

To ensure the bottom chamber 120 move vertically along a predetermined path with minimal deviation (e.g., less than 0.1 millimeters), roller device(s) 180R is disposed on the side(s) of the frame 180F. The roller device 180R presses against the bottom chamber 120 to enhance the stability and smooth control of its lateral movement. Guiding the bottom chamber 120 along the predetermined path is crucial to align the bottom chamber 120 with the structural device 10D or the top chamber 110, thereby precisely positioning the bottom chamber 120.

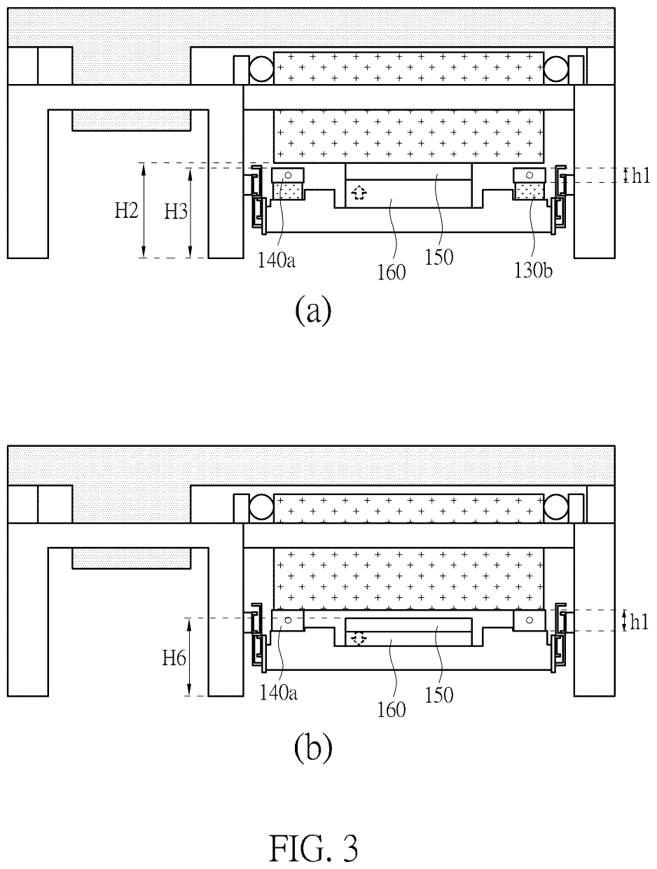

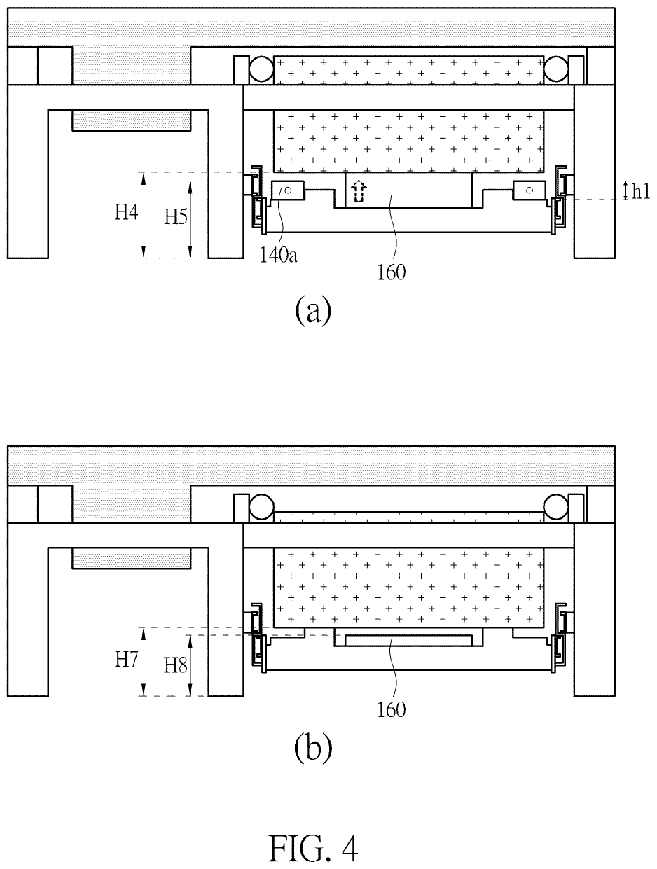

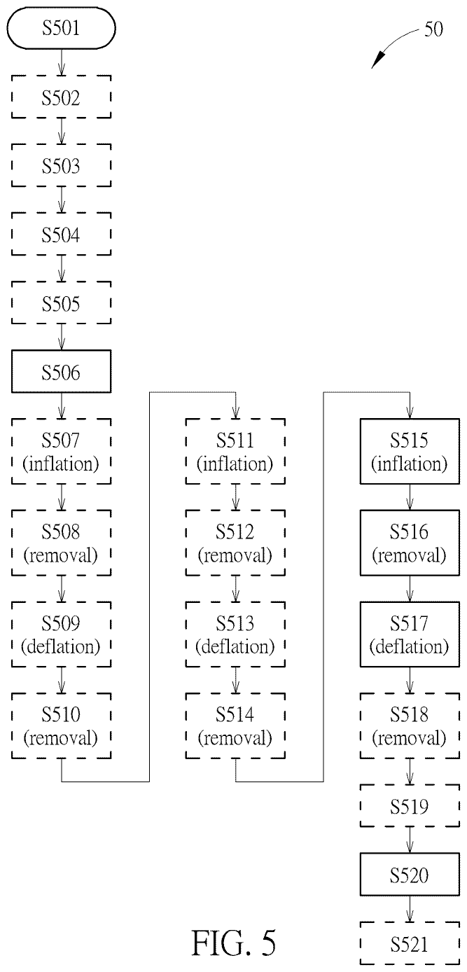

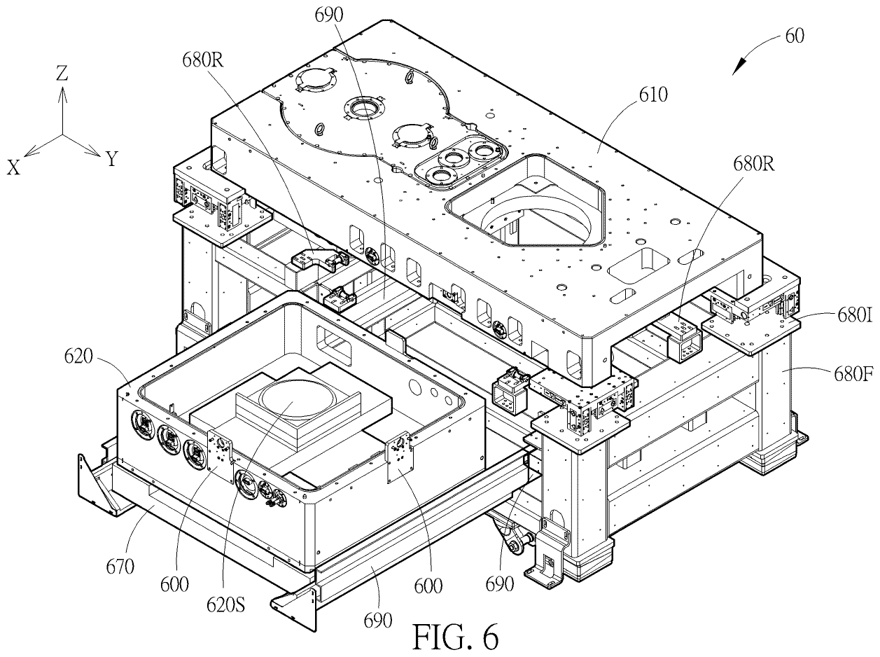

A moving method 50 shown in FIG. 5 is suitable for the structural device 10 and may comprise the following steps:
Step S501: Start. As shown in FIG. 1, the top chamber 110, the plate 170, the bar frame 180B, the frame 180F, the components 180I, the roller device 180R, and the slide rail 190 are assembled together. The height adjustable device 130, the (first) spacer device 140, or a (third) spacer device (not shown) rest on the plate 170. The bottom chamber 120, above the height adjustable device 130, is fixed to the top chamber 110. Next, proceed to step S502 or S504.
Step S502: Place the pneumatic lifting device 160 on the plate 170. Step S502 may be omitted if the pneumatic lifting device 160 is already placed. Next, proceed to step S503.
Step S503: Stack the (second) spacer 150 or a (fourth) spacer on the pneumatic lifting device 160, as shown in FIG. 1. Step S503 may be omitted if the spacer 150 or the fourth spacer is already placed. Next, proceed to step S504, S505, or S506.
Step S504: Increase the height of the height adjustable device 130 (to its highest height h2) to support the bottom chamber 120, as shown in FIG. 2(a). Step S504 may be omitted if the bottom chamber 120 is already supported by the height adjustable device 130. Next, proceed to step S505 or S506.
Step S505: Loosen the fastener(s) 100 between the top chamber 110 and the bottom chamber 120. Step S505 may be omitted if the fastener(s) 100 has/have been be taken out. Next, proceed to step S506.
Step S506: Decrease the height of the height adjustable device 130 (to its lowest height h1) to lower the bottom chamber 120, as shown in FIG. 2(b). Next, proceed to step S507, S511, or S515.
Step S507: Inflate the pneumatic lifting device 160 until the bottom chamber 120 is (fully) supported by the pneumatic lifting device 160 and separated from the height adjustable device 130, the spacer device 140, or the third spacer device. The positions of the height adjustable device 130, the spacer device 140, or the (third) spacer device are interchangeable, providing flexibility in their arrangement. Step S507 may be omitted if the third spacer device is unnecessary or not present. Next, proceed to step S508.
Step S508: Remove the third spacer device. The third spacer device can be easily moved relative to the spacer 150 or the second spacer as it does not bear the weight of the bottom chamber 120. Next, proceed to step S509, S512, or S516.
Step S509: Deflate the pneumatic lifting device 160 until the bottom chamber 120 is supported by the height adjustable device 130 and separated from the spacer 150 or the second spacer. Step S507 may be omitted if the second spacer is unnecessary or not present. Next, proceed to step S510.
Step S510: Remove the second spacer. Next, proceed to step S511, S514, or S518.
Step S511: Inflate the pneumatic lifting device 160 until the bottom chamber 120 is (fully) supported by the pneumatic lifting device 160 and separated from the height adjustable device 130 or the spacer device 140, as shown in FIG. 3(a). During the second stoke of the pneumatic lifting device 160, the bottom chamber 120 is raised, creating a gap between the height adjustable device 130 (or the spacer device 140) and the bottom chamber 120. Step S511 may be omitted if a single stoke of the pneumatic lifting device 160 is sufficient to lift the bottom chamber 120 to a desired elevation, and the spacer device 140 is unnecessary or not present. Next, proceed to step S512.
Step S512: Remove the spacer device 140. Next, proceed to step S513 or S516.
Step S513: Deflate the pneumatic lifting device 160 until the bottom chamber 120 is supported by the height adjustable device 130 and separated from the spacer 150. As shown in FIG. 3(b), the bottom chamber 120 descends smoothly to a specified position. Step S513 may be omitted if the spacer 150 is unnecessary or not present. Next, proceed to step S514.
Step S514: Remove the spacer 150. Next, proceed to step S515 or S518.
Step S515: Inflate the pneumatic lifting device 160 until the bottom chamber 120 is (fully) supported by the pneumatic lifting device 160 and separated from the height adjustable device 130, as shown in FIG. 4(a). Next, proceed to step S516.
Step S516: Remove height adjustable device 130. Next, proceed to step S517.
Step S517: Deflate the pneumatic lifting device 160 until the bottom chamber 120 is supported by the plate 170 and separated from the pneumatic lifting device 160, as shown in FIG. 4(b). Next, proceed to step S518 or S519.
Step S518: Remove the pneumatic lifting device 160. Step S518 may be omitted. Next, proceed to step S519.
Step S519: Take out the removable bar frame 180B from the frame 180F. Step S519 may be omitted if the bar frame 180B is unnecessary or not present. Next, proceed to step S520.
Step S520: Slide the plate 170 along the slide rail 190 in the +X direction (e.g., FIG. 6). The bottom chamber 120 is moved together with the plate 170. Next, proceed to step S521.
Step S521: Remove the bottom chamber 120 from the plate 170. The transportation or maintenance of the bottom chamber 120 is performed as required. Step S521 may be omitted.

The order of certain steps may be change. For example, steps S504 and S505 may be performed earlier, such as prior to step S502. Steps S519 and S520 may be performed earlier, such as prior to step S518. Step S519 may be performed earlier, such as prior to step S502 or S518.

It will be apparent that once the bottom chamber 120 has been lowered to a desired height, it may be supported at that height by the plate 170, and then, if desired, lifted back to a higher level by reversing the above-described process. For example, a moving method is suitable for the structural device 10 and may comprise the following steps:
Step S601: Start. The top chamber 110, the plate 170, the frame 180F, the components 180I, the roller device 180R, and the slide rail 190 are joined together. Next, proceed to step S602 . . . or S606.
Step S602: Place the pneumatic lifting device 160 on the plate 170. Next, proceed to step S603.
Step S603: Place the bottom chamber 120 above the pneumatic lifting device 160. Next, proceed to step S604.
Step S604: Slide the plate 170 along the slide rail 190 in the −X direction (e.g., FIG. 6). Next, proceed to step S605 or S606.
Step S605: Secure the bar frame 180B to the frame 180F, as shown in FIG. 4(b). Alternatively, secure the bottom chamber 120 into the detachable frame 180B. Next, proceed to step S606.
Step S606: Inflate the pneumatic lifting device 160 until the bottom chamber 120 is (fully) supported by the pneumatic lifting device 160 and separated from the plate 170. The first stoke of the pneumatic lifting device 160 raise the bottom chamber 120 and create a gap between the plate 170 and the bottom chamber 120. Next, proceed to step S607.
Step S607: Place the height adjustable device 130 on the plate 170, as shown in FIG. 4(a), to partially or fully fill the gap. Next, proceed to step S608, S611, or S615.
Step S608: Deflate the pneumatic lifting device 160 until the bottom chamber 120 is supported by the height adjustable device 130 and separated from the pneumatic lifting device 160. Next, proceed to step S609 or S617.
Step S609: Stack the spacer 150 on the pneumatic lifting device 160, as shown in FIG. 3(b). Next, proceed to step S610 or S613.
Step S610: Inflate the pneumatic lifting device 160 until the bottom chamber 120 is (fully) supported by the pneumatic lifting device 160 and separated from the height adjustable device 130. As shown in FIG. 3(a), the bottom chamber 120 ascends vertically and steadily. (Horizontal) alignment adjustments can be made by utilizing the pneumatic lifting device 160, which allows free movement across a flat surface (e.g., 170S1). Next, proceed to step S611.
Step S611: Stack the spacer device 140 on/beneath the height adjustable device 130, as shown in FIG. 3(a). Next, proceed to step S612, or S615.
Step S612: Deflate the pneumatic lifting device 160 until the bottom chamber 120 is supported by the height adjustable device 130 and separated from the pneumatic lifting device 160 or the spacer 150, as shown in FIG. 2(b). Next, proceed to step S613 or S617.
Step S613: Stack the fourth spacer on the pneumatic lifting device 160. Next, proceed to step S614.
Step S614: Inflate the pneumatic lifting device 160 until the bottom chamber 120 is (fully) supported by the pneumatic lifting device 160 and separated from the height adjustable device 130 or the spacer device 140. The weight of the bottom chamber 120 is transferred from the height adjustable device 130 to the pneumatic lifting device 160. Next, proceed to step S615.
Step S615: Stack the third spacer device on/beneath the height adjustable device 130. Next, proceed to step S616.
Step S616: Deflate the pneumatic lifting device 160 until the bottom chamber 120 is supported by the height adjustable device 130 and separated from the pneumatic lifting device 160, the spacer 150, or the fourth spacer. Next, proceed to step S617.
Step S617: Increase the height of the height adjustable device 130, as shown in FIG. 2(a). The bottom chamber 120 is supported by the height adjustable device 130 for further installation and fixation. Next, proceed to step S618 . . . or S621.
Step S618: Secure the bottom chamber 120 to the top chamber 110 using the fastener(s) 100. Next, proceed to step S619, S620, or S621.
Step S619: Remove the spacer 150 or the fourth spacer. Next, proceed to step S620 or S621.
Step S620: Remove the pneumatic lifting device 160. Next, proceed to step S621.
Step S621: Decrease the height of the height adjustable device 130, as shown in FIG. 1. Step S621 may be omitted.

It can be seen that the plate 170 functions as a single input single output (SISO) plate. As the weight of the bottom chamber 120 is transferred between the height adjustable device 130 and the pneumatic lifting device 160, the bottom chamber 120 moves along a vertical line. The plate 170 guides the bottom chamber 120 to move horizontally, featuring a single input and output.

The plate 170 is meticulously designed with a sophisticated structure. For example, the plate 170 features multiple surfaces of different heights (e.g., 170S1-170S3). As shown FIG. 1, the pneumatic lifting device 160 is disposed on the (first) surface 170S1, which is lower than the surface 170S2 or 170S3. Besides, the height adjustable device 130 is disposed on the (second) surface 170S2. As shown FIG. 4(b), the bottom chamber 120 rests on the (third) surface 170S3. This design of the plate 170 may facilitate the smooth transfer of the bottom chamber's weight between multiple piles of supporting components (e.g., the spacer 140a . . . 150, the height adjustable device 130, and the pneumatic lifting device 160).

Specifically, heights are listed in descending order as follows: a height H1 of the bottom surface of the bottom chamber 120 fixed to the top chamber 110, a height H2 of the spacer 150 placed on the inflated pneumatic lifting device 160, a height H3 of the height adjustable device 130 (at the height h1) located on the spacer device 140, a height H4 of the inflated pneumatic lifting device 160, a height H5 of the height adjustable device 130 at the height h1, a height H6 of the spacer 150 stacked on the deflated pneumatic lifting device 160, a height H7 of the surface 170S3, and a height H8 of the deflated pneumatic lifting device 160. The variations in height ensure efficient operation of weight transfer.

In FIG. 1, there may be one spacer 150; however, the present invention is not limited thereto and the lowering step (e.g., S507-S510) may be repeated to enable the placement of more spacers (e.g., 650a-650c). In this manner, any number of spacers may be stacked on one another to elevate/lower the bottom chamber 120 to a desired height.

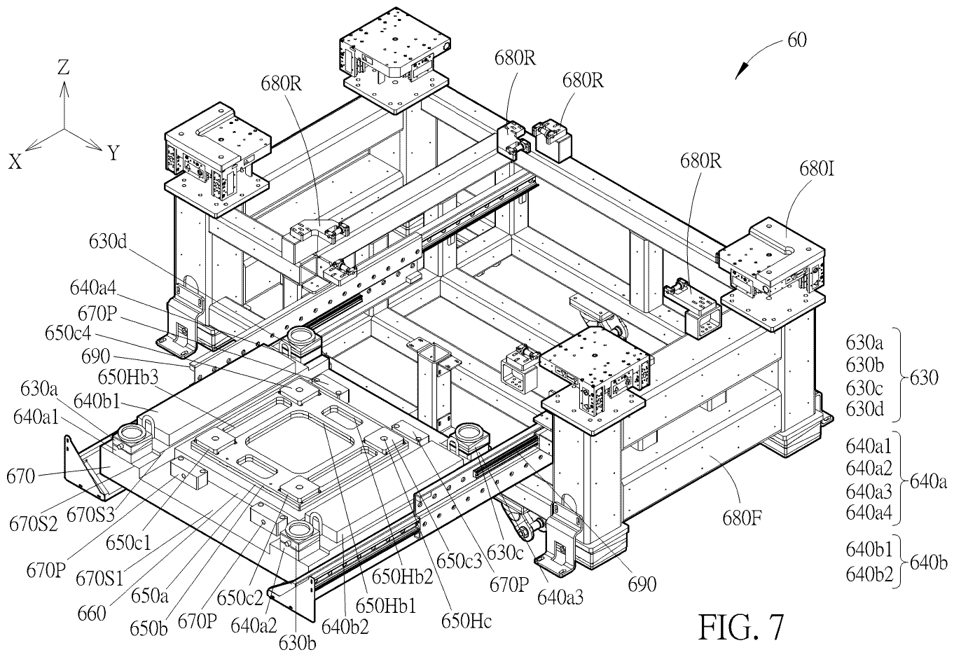

For example, FIGS. 6-10 are schematic diagrams of a system 60, which may be implemented using the system 10, according to an embodiment of the present invention. FIGS. 6 and 7 illustrate different components of the system 60 under the same view.

As shown in FIG. 7, the system 60 comprises spacer devices 640a-640b, which are mountable beneath/near a height adjustable device 630, and spacers 650a-650c4, which are mountable on a pneumatic lifting device 660. The spacer device 640a comprises spacers 640a1-640a4; the spacer device 640b comprise spacers 640b1-640b2. By using more than one spacer, a bottom chamber 620 can be efficiently moved to elevations beyond what a spacer alone can achieve. Besides, as a spacer is divided into two, each spacer becomes lighter (e.g., less than 10 kilograms) and easier to move manually.

Although the spacers 650a-650c1 are depicted as separate spacers in FIG. 7, they may be removably connected to one another, offering flexibility in their use.

A spacer may be patterned or hollowed to reduce weight. For example, as shown in FIG. 7, the (second) spacer 650a and the (fourth) spacer 650b . . . 650c4 comprises holes/grooves (e.g., 650Hb1-650Hb3, and 650Hc) to make them weigh less. The holes 650Hb1 and 650Hc are located at the center of the spacer 650b-650c4, respectively. Holes (e.g., 650Hb2 and 650Hb3) near the edge of a spacer (e.g., 650Hb) may vary in size; alternatively, the two marginal holes 650Hb2 have similar sizes. As shown in FIG. 7, a spacer (e.g., 640a1 or 650c1) may be a rectangular cuboid or adopt other geometries such as polyhedron or cylinder. Alternatively, a spacer (e.g., 640a1 or 650c1) may feature an I-shaped or H-shaped cross-section to decrease its mass.

The spacers are arranged in an organized/symmetrical manner. As shown in FIG. 7, each leveling wedge 630a . . . or 630d of the height adjustable device 630 may be substantially aligned with a (first) spacer (e.g., 640a1 . . . or 640a4) of the spacer device 640 or a third spacer (not shown). The leveling wedges 630a-630d are similar in size or weight; the spacers 640a1-640a4 are similar in size or weight. Besides, the pneumatic lifting device 660 may be substantially aligned with the spacer(s) 650a . . . or 650c4, which may be similar in size or weight. The spacer 650b or 650c1 at least partially overlaps the spacer 650a or the pneumatic lifting device 660. Moreover, each spacer (e.g., 640a . . . 650c4) exhibits symmetry. Overall, the spacers also possess (mirror/rotational) symmetric relative to the central axis of the bottom chamber 120. This symmetrical/organized arrangement can help evenly distribute the weight of the bottom chamber 120 among the spacers, enhancing stability and load management.

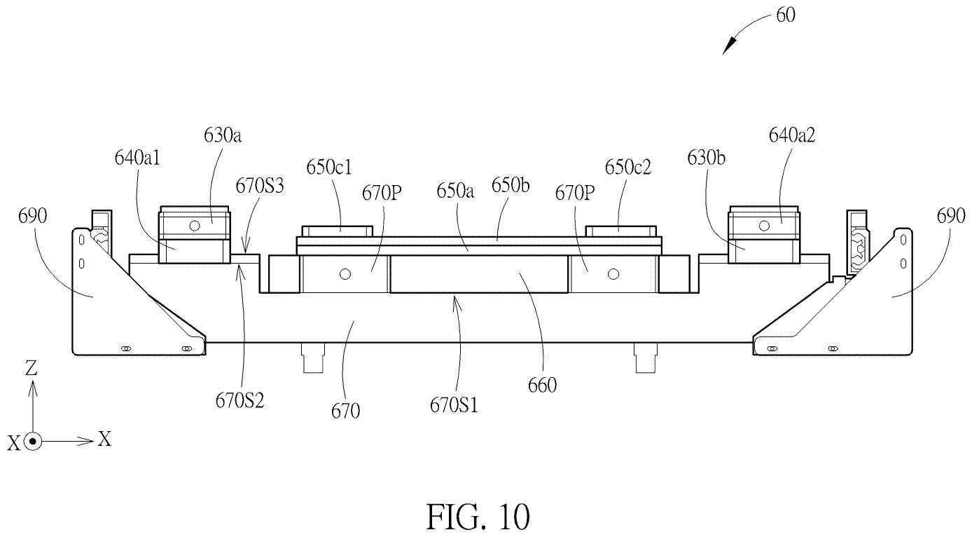

The shape of a plate 670 is meticulously designed. For example, FIG. 10 illustrates the side-view of the leveling wedges 630a-630b, the spacers 640a1-640a2, 650a-650c2, the pneumatic lifting device 660, the plate 670, and a set of slide rail 690. As shown in FIGS. 7 and 10, a (first) surface 670S1 of the plate 670, on which the pneumatic lifting device 660 is disposed, is lower than a (second) surface 670S2, on which the height adjustable device 630 is disposed, or a (third) surface 670S3, on which the bottom chamber 620 is disposed. Besides, the spacer 650b or 650c1 is thinner than the height adjustable device 630 or the (first) spacer device 640. Given that the minimum distance between a top chamber 610 and the plate 670 is limited and may be substantially less than 1.5 times the thickness of the bottom chamber 620, the plate 670 is designed with the surfaces 670S1-670S3 at varying heights to accommodate these constraints.

Besides, as shown in FIGS. 7 and 9-10, the plate 670 comprises protrusion(s) 670P to confine the pneumatic lifting device 660 in place. The shape/size of the protrusion(s) 670P may vary as long as it is high/wide enough to constrain the pneumatic lifting device 660, so that the pneumatic lifting device 660 will not slip off the plate 670.

The top chamber 610 and the bottom chamber 620 shown in FIG. 6 may be assembled into a unified device (e.g., an inspection device), which may be evacuated to create a vacuum when engaged. As shown in FIG. 6, an inspection stage 620S may be positioned within the bottom chamber 620. A light source, optical lens/lenses, or an end effector (not shown) may be located within the top chamber 610.

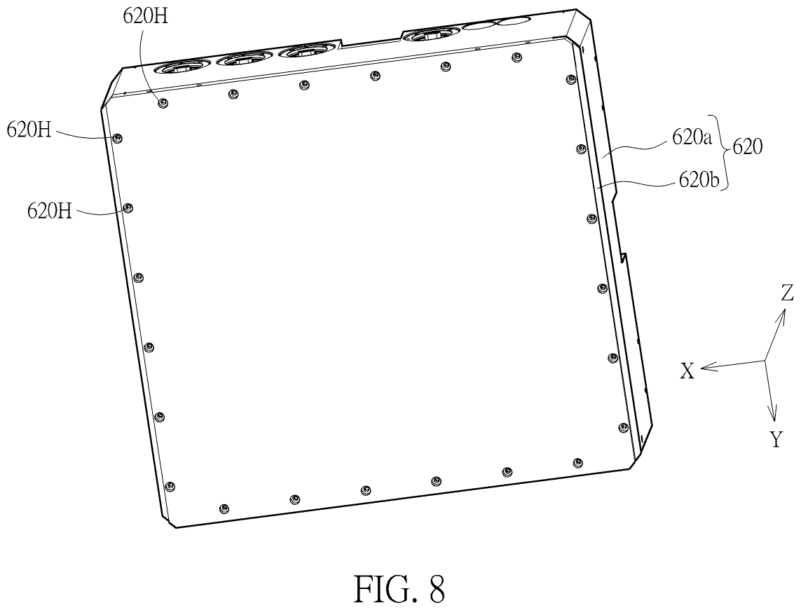

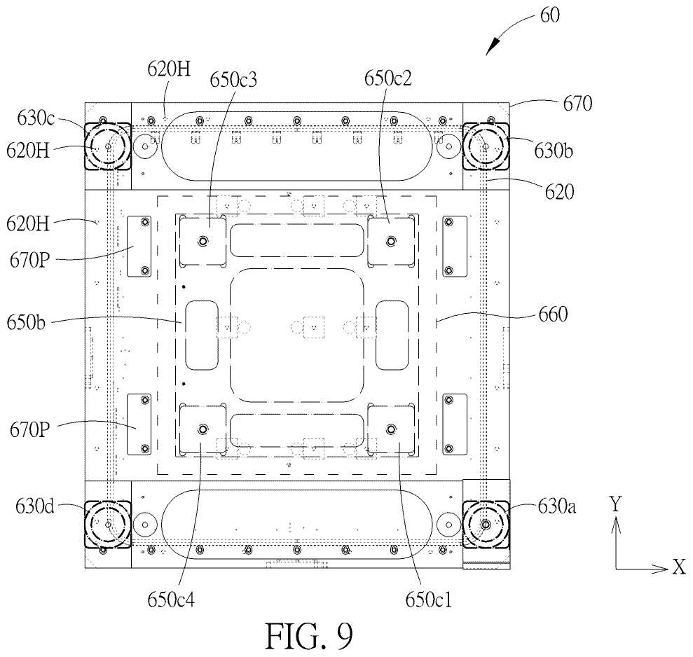

As shown in FIG. 8, the bottom chamber 620 may comprise two components 620a and 620b. Particle reducer(s) (not shown) may be disposed with in an accommodation space between the two components 620a and 620b to attract charged particles or debris. To repair or clean the particle reducer(s), fasteners (not shown) can be removed following step S504, allowing the component 620b to be detached and moved away from the component 620a. FIG. 9 illustrates the top-view of the bottom chamber 620 (thin dotted lines), the leveling wedges 630a-630d (thick dot-dashed lines), the spacers 650b-650c4 (thin dot-dot-dashed lines), the pneumatic lifting device 660 (thin dashed lines), and the plate 670 (thin solid lines). As shown in FIG. 9, holes 620H, designed for the fasteners to be screwed into the components 620a and 620b, remain uncovered and unobstructed b by the height adjustable device 630 or the spacer device 640.

To sum up, by moving the heavy bottom chamber between multiple piles of supporting component(s) (e.g., spacer(s), a height adjustable device, and a pneumatic lifting device), it is possible to achieve the vertical lifting and horizontal movement of the heavy bottom chamber simultaneously, thereby facilitates the handling of the heavy bottom chamber that is beyond the capacity of manual handling in a confined space.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A moving method, for progressively moving a bottom chamber away from a top chamber, wherein the moving method comprises:
decreasing a height of a height adjustable device to lower the bottom chamber;
inflating a pneumatic lifting device until the bottom chamber is supported by the pneumatic lifting device and separated from the height adjustable device or a first spacer device, wherein the first spacer device is mountable on or beneath the height adjustable device;
removing the first spacer device;
deflating the pneumatic lifting device until the bottom chamber is supported by the height adjustable device and separated from a second spacer, wherein the second spacer is mountable on the pneumatic lifting device;
removing the second spacer;
inflating the pneumatic lifting device until the bottom chamber is supported by the pneumatic lifting device and separated from the height adjustable device;
removing the height adjustable device; and
deflating the pneumatic lifting device until the bottom chamber is supported by a plate and separated from the pneumatic lifting device.

2. The moving method of claim 1, further comprising:
placing the pneumatic lifting device on the plate, wherein the pneumatic lifting device is an air caster confined by at least one protrusion of the plate;
stacking the second spacer on the pneumatic lifting device;
increasing the height of the height adjustable device to support the bottom chamber; and
loosening at least one fastener, configured for securing the bottom chamber to the top chamber.

3. The moving method of claim 1, further comprising:
inflating the pneumatic lifting device until the bottom chamber is supported by the pneumatic lifting device and separated from the height adjustable device, the first spacer device, or a third spacer device, wherein the first spacer device is mountable on or beneath the third spacer device; and
removing the third spacer device;
wherein the height adjustable device comprises at least one leveling wedge;
wherein the first spacer device comprises at least one first spacer;
wherein the third spacer device comprises at least one third spacer;
wherein each leveling wedge is aligned with one first spacer or one third spacer.

4. The moving method of claim 1, further comprising:
deflating the pneumatic lifting device until the bottom chamber is supported by the height adjustable device and separated from a fourth spacer, which is mountable on the pneumatic lifting device or the second spacer, wherein the fourth spacer at least partially overlaps the second spacer or the pneumatic lifting device; and
removing the fourth spacer;
wherein the second spacer or the fourth spacer comprises at least one hole or groove and has symmetry.

5. The moving method of claim 1, further comprising:
removing the pneumatic lifting device, which is placed on a first surface of the plate;
sliding the plate along a slide rail, wherein the bottom chamber is placed on a third surface of the plate; and
removing the bottom chamber from the plate;
wherein the height adjustable device has been removed from a second surface of the plate;
wherein the first surface is lower than the second surface or the third surface.

6. The moving method of claim 1, wherein at least one roller device is configured to control lateral movement of the bottom chamber relative to the top chamber.

7. The moving method of claim 1,
wherein a minimum distance between the top chamber and the plate is substantially less than 1.5 times a height of the bottom chamber; or
wherein the second spacer or a fourth spacer is thinner than the height adjustable device or the first spacer device.

8. A moving method, for progressively moving a bottom chamber toward a top chamber, wherein the moving method comprises:
inflating a pneumatic lifting device on a plate until the bottom chamber is supported by the pneumatic lifting device;
placing a height adjustable device on the plate;
deflating the pneumatic lifting device until the bottom chamber is supported by the height adjustable device and separated from the pneumatic lifting device;
placing a second spacer on the pneumatic lifting device;
inflating the pneumatic lifting device until the bottom chamber is supported by the pneumatic lifting device and separated from the height adjustable device;
placing a first spacer device on or beneath the height adjustable device;
deflating the pneumatic lifting device until the bottom chamber is supported by the height adjustable device and separated from the second spacer;
increasing a height of the height adjustable device to lift the bottom chamber.

9. The moving method of claim 8, further comprising:
placing the bottom chamber on a third surface of the plate;
sliding the plate along a slide rail; and
securing a frame;
placing the pneumatic lifting device on a first surface of the plate; and
wherein the height adjustable device is mountable on a second surface of the plate;
wherein the first surface is lower than the second surface or the third surface.

10. The moving method of claim 8, further comprising:
inflating the pneumatic lifting device until the bottom chamber is supported by the pneumatic lifting device and separated from the height adjustable device or the first spacer device; and
disposing a third spacer device on or beneath the height adjustable device;
wherein the height adjustable device comprises at least one leveling wedge;
wherein the first spacer device comprises at least one first spacer;
wherein the third spacer device comprises at least one third spacer;
wherein each leveling wedge is aligned with one first spacer or one third spacer.

11. The moving method of claim 8, further comprising:
placing a fourth spacer on the pneumatic lifting device or the second spacer, wherein the fourth spacer at least partially overlaps the second spacer or the pneumatic lifting device; and
deflating the pneumatic lifting device until the bottom chamber is supported by the height adjustable device and separated from the pneumatic lifting device, the fourth spacer, or the second spacer;
wherein the second spacer or the fourth spacer comprises at least one hole or groove and has symmetry.

12. The moving method of claim 8, further comprising:
securing the bottom chamber to the top chamber using at least one fastener; and
removing the pneumatic lifting device, wherein the pneumatic lifting device is an air caster confined by at least one protrusion of the plate.

13. The moving method of claim 8, wherein at least one roller device is configured to control lateral movement of the bottom chamber relative to the top chamber.

14. The moving method of claim 8,
wherein a minimum distance between the top chamber and the plate is substantially less than 1.5 times thickness of the bottom chamber; or
wherein the second spacer or a fourth spacer is thinner than the height adjustable device or the first spacer device.

15. A structural device, for progressively moving a bottom chamber either away from or toward a top chamber, wherein the structural device comprises:
a plate;
a first spacer device, mountable on the plate;
a height adjustable device, mountable on or beneath the first spacer device, wherein the height adjustable device comprises at least one simple machine to adjust a height thereof;
a pneumatic lifting device, mountable on the plate, wherein the pneumatic lifting device is inflatable and deflatable to adjust a height thereof;
a second spacer, mountable on the pneumatic lifting device;
wherein the bottom chamber is mountable on the plate, the height adjustable device, the first spacer device, the pneumatic lifting device, or the second spacer.

16. The structural device of claim 15, further comprising:
at least one fastener, configured to secure the bottom chamber to the top chamber;
a slide rail, wherein the plate is slidable along the slide rail;
a frame, mountable to the bottom chamber; or
at least one roller device, configured to control lateral movement of the bottom chamber relative to the structural device.

17. The structural device of claim 15,
wherein the plate comprises at least one protrusion configured to confined the pneumatic lifting device,
wherein the pneumatic lifting device is an air caster.

18. The structural device of claim 15, further comprising:
a third spacer device, mountable on or beneath the first spacer device, wherein the first spacer device comprises at least one first spacer, wherein the third spacer device comprises at least one third spacer, wherein the height adjustable device comprises at least one leveling wedge, wherein each leveling wedge is aligned with one first spacer or one third spacer; or
a fourth spacer, mountable on the pneumatic lifting device or the second spacer, wherein the fourth spacer is at least partially overlaps the second spacer or the pneumatic lifting device, wherein the second spacer or the fourth spacer comprises at least one hole or groove and has symmetry.

19. The structural device of claim 15,
wherein the pneumatic lifting device is mountable on a first surface of the plate;
wherein the height adjustable device is mountable on a second surface of the plate;
wherein the bottom chamber is mountable on a third surface of the plate;
wherein the first surface is lower than the second surface or the third surface.

20. The structural device of claim 15,
wherein a minimum distance between the top chamber and the plate is substantially less than 1.5 times thickness of the bottom chamber; or
wherein the second spacer or a fourth spacer is thinner than the height adjustable device or the first spacer device.
